(19) United States
(12) Patent Application Publication
(10) Pub. No.: US 2006/0244833 A1
(43) Pub. Date: Nov. 2, 2006

(54) Camera apparatus and data transfer method

(75) Inventors: Tatsuro Abe, Ome-shi (JP); Shiro Nagaoka, Ome-shi (JP); Tatsuhiko Ikehata, Ome-shi (JP); Toyokazu Aizawa, Sagamihara-shi (JP); Kei Tashiro, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/346,428

(22) Filed: Feb. 3, 2006

(30) Foreign Application Priority Data
Apr. 28, 2005 (JP) 2005-132650

(51) Int. Cl. H04N 5/225

(52) U.S. Cl. 348/207.1

(57) ABSTRACT

According to one embodiment, a camera apparatus comprises an adapter connecting section. The adapter connecting section can be connected to a cradle. An arbitrary number of external recording apparatuses are connected to the camera apparatus via the cradle. An image signal stored in a recording medium of the camera apparatus can be output to the external recording apparatuses via the cradle through a LAN. A monitor section of the camera apparatus can display the arbitrary number of external recording apparatuses, to which the image signal stored in the recording medium of the camera apparatus can be transferred.

### CROSS-REFERENCE TO RELATED APPLICATIONS

This application is based upon and claims the benefit of priority from prior Japanese Patent Application No. 2005-132650, filed Apr. 28, 2005, the entire contents of which are incorporated herein by reference.

### BACKGROUND

1. Field

One embodiment of the invention relates to a method for transferring a moving picture taken by an electronic camera or the like and a camera apparatus capable of independently executing the transfer.

2. Description of the Related Art

An electronic camera apparatus can record a moving picture or still picture in a recording medium, such as a semiconductor memory (memory card) or a hard disk. In recent years, the hard disk has become compact and the capacity thereof has increased. Therefore, some types of camera apparatus, which have been in practical use, are capable of recording (storing) long-time moving pictures of many titles and many still pictures.

The storage capacity ensured in a hard disk corresponds to about several thousands of still pictures, or several hours of moving pictures (about several hundreds of titles).

A moving picture or still picture taken by an electronic camera apparatus can be transferred to a personal computer, or a recording/reproducing apparatus, which records or reproduces an image file of a compatible standard (format). In reverse, a moving picture or still picture can be transferred from the personal computer or the recording/reproducing apparatus to the electronic camera.

Jpn. Pat. Appln. KOKAI Publication No. 2003-234987 proposes an image pickup apparatus, which has a communicating section connectable to a wireless network and can selectively receives a still picture stored in another image pickup apparatus connected thereto by the wireless network.

Jpn. Pat. Appln. KOKAI Publication No. 2003-234987 describes handling of still pictures, but not of moving pictures. Further, it cannot be confirmed, from this publication, that the subject to be connected to the wireless network includes a recording/reproducing apparatus which records or reproduces an image file of a compatible format. Furthermore, the publication discloses that an image pickup apparatus can selectively receive a still picture stored in another image pickup apparatus, but does not explicitly shows that the image taken by the image pickup apparatus can be stored in another image pickup apparatus.

In particular, there is no prior art document, which describes a method and structure for transferring a moving picture between an image pickup apparatus and an image (moving picture) recording/reproducing apparatus, which has a large-capacity memory medium, for example, a hard disk, as a recording medium, and which can store long-time moving pictures.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1A is a schematic diagram showing an exemplary camera apparatus capable of recording a moving picture, still picture, sound, etc., to which an embodiment of the invention;

FIG. 1B is a schematic diagram showing the exemplary camera apparatus capable of recording a moving picture, still picture, sound, etc., to which an embodiment of the invention;

FIG. 2 is a schematic diagram showing an exemplary cradle for use in connecting the camera apparatus shown in FIGS. 1A and 1B with an external recording apparatus in the embodiment;

FIG. 3 is a schematic diagram showing an example of connection via the cradle shown in FIG. 2 between the camera apparatus and an arbitrary number of external recording apparatuses connected to a network;

FIG. 4 is a schematic diagram for explaining an example of the control block of the camera apparatus shown in FIGS. 1A and 1B according to an embodiment of the invention;

FIG. 5 is a schematic diagram showing an exemplary indication (“connection check screen”) displayed in a monitor section of the camera apparatus in the embodiment, in which the connection with the arbitrary number of external recording apparatuses shown in FIG. 3 is displayed as viewed from the camera apparatus;

FIG. 6 is a schematic diagram showing exemplary an indication (“equipment selection screen”) displayed in the monitor section of the camera apparatus in the embodiment, in which the connection with the arbitrary number of external recording apparatuses shown in FIG. 3 is displayed as viewed from the camera apparatus;

FIG. 7 is a schematic diagram showing an exemplary indication (“drive selection screen”) displayed in the monitor section of the camera apparatus in the embodiment, in which the connection with the arbitrary number of external recording apparatuses shown in FIG. 3 is displayed as viewed from the camera apparatus;

FIG. 8 is a schematic diagram showing an exemplary indication (“moving picture selection screen”) indicative of a sequence of transferring image data (moving picture) from the camera apparatus to the recording medium selected by the sequences shown in FIGS. 5 to 7; and

FIG. 9 is a schematic diagram showing an exemplary indication subsequent to the “moving picture selection screen” shown in FIG. 8.

### DETAILED DESCRIPTION

Various embodiments according to the invention will be described hereinafter with reference to the accompanying drawings. In general, according to one embodiment of the invention, a camera apparatus comprises an adapter connecting section. The adapter connecting section can be connected to a cradle. An arbitrary number of external recording apparatuses are connected to the camera apparatus via the cradle. An image signal stored in a recording medium of the camera apparatus can be output to the external recording apparatuses via the cradle through a LAN. A monitor section of the camera apparatus can display the arbitrary number of external recording apparatuses, to which the image signal stored in the recording medium of the camera apparatus can be transferred.

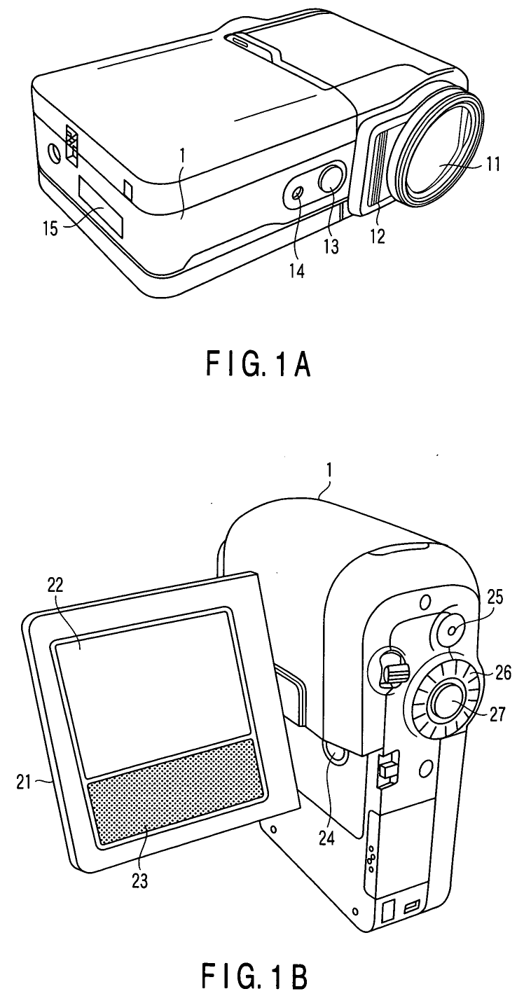

FIGS. 1A and 1B are schematic diagrams showing a camera apparatus capable of recording a moving picture, still picture, sound, etc., to which the present invention is applicable.

FIG. 1A shows a state of an electronic camera apparatus (image pickup apparatus) 1 as viewed from the side of an image pickup lens.

An electronic camera apparatus 1 has an image pickup lens 11, a flash 12, a shutter button (for taking a still picture) 13, a remote control receiving section 14, etc. The electronic camera apparatus 1 also has an adapter connecting section (connecting terminal) 15 for use in connection with a personal computer, an external power supply (charger), etc.

FIG. 1B shows a state of the electronic camera apparatus 1 as viewed from the reverse side of the image pickup lens 11.

The electronic camera apparatus 1 further has a liquid crystal monitor (LCD panel) 22 and a speaker 23, which are formed integrally with a frame 21 serving to turn on and off main power. Furthermore, the electronic camera apparatus 1 has, in a predetermined position of the body, a main power switch 24 that is turned off when the frame 21 is closed (held in the predetermined position of the body of the electronic camera).

The electronic camera apparatus 1 is provided with a record button 25, a jog dial 26 and an OK button 27 in predetermined positions. The record button 25 allows input of instructions (control commands) to start and stop (end) recording of a moving picture. The jog dial 26 allows input of instructions (control commands) to select instructions of input and decision of an operation mode or various conditions. The OK button 27 allows input of instructions (control commands) to confirm (execute) instructions selected (guided) by the jog dial 26. The OK button 27 is positioned, for example, coaxially (concentrically) with respect to the center of rotation of the jog dial 26.

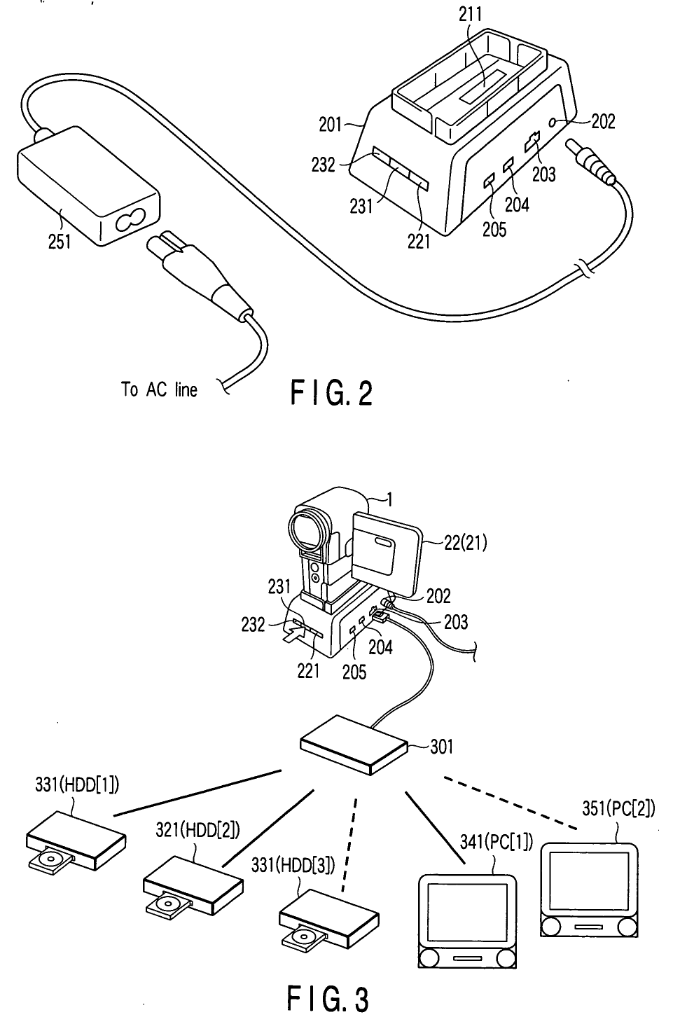

FIG. 2 is a schematic diagram showing a camera holding unit (cradle), which makes it possible to supply power to the electronic camera apparatus and transfer control signals and image data via the adapter connecting section 15 shown in FIGS. 1A and 1B.

The cradle 201 functions as a data transfer apparatus. It allows the camera apparatus 1 to independently transfer image data (moving picture or still picture) and a folder (album) containing a plurality of image data items under a predetermined condition between the electronic camera apparatus 1 and an image information recording apparatus, such as a recording/reproducing apparatus equipped with a hard disk and connected to a personal computer or a TV receiver.

The cradle 201 comprises a power supply terminal (connector portion) 202, a LAN (Local Area Network) terminal (connector portion) 203, a USB (Universal Serial Bus) terminal 204, and an A/V output terminal (connector portion) 205. The power supply terminal 202 is supplied with DC output from an AC adapter 251, which converts an AC voltage supplied through a commercial line to, for example, 5V DC adapted to operations of the camera apparatus 1. The LAN terminal 203 is used to connect the camera apparatus to a LAN widely available as a public network. The USB terminal 204 is used to transfer data between the camera apparatus 1 and a personal computer. The A/V output terminal 205 is used to directly input analog audio and video signals directly to, for example, a TV receiver.

The terminals 202 to 205 are connected to a contact portion 211 provided in a predetermined position in the cradle 201, so that they can be electrically connected to the adapter connecting section 15 of the camera apparatus 1.

The cradle 201 also has a power button (power supply switch) 221, which can set supply or shutdown of the 5V DC to the electronic camera apparatus 1 set in the cradle 201, in the state where the AC adapter 251 is connected to a commercial line not shown. The power button 221 incorporates an LED element, which is not described in detail. When the power button 221 is pushed in (turned on), light of a predetermined color is output and the 5V DC from the AC adapter 251 is supplied to the camera apparatus 1. Then, when the power button 221 is pushed in again, the 5V DC is shutdown and the light output is turned off.

Further, the cradle 201 has a LAN button (LAN switch) 231 and a USB button (USB switch) 232. The LAN button 231 is used to connect with or disconnect from a router (hub) connected to the LAN terminal 203 through a LAN cable. The USB button 232 is used to connect with or disconnect from a personal computer or an external memory device (external HDD, USB memory, or the like) connected to the USB terminal 204 through a USB cable. The LAN button 231 and the USB button 232 are selective switches; that is, when one of them is on (pushed in), the other is off. Each of the LAN button 231 and the USB button 232 incorporates an LED, which is not described in detail. The LED corresponding to the presently selected connecting system (pushed-in button) is turned on.

FIG. 3 is a schematic diagram showing a state in which the camera apparatus 1 is mounted on the cradle 201 shown in FIG. 2 and the camera apparatus 1 is connected to a router 301 through the LAN cable connected to the LAN terminal 203.

The router 301 connected to the camera apparatus 1 via the cradle 201 is connected to, for example, a first information recording apparatus (HDD-equipped DVD recorder [1], hereinafter referred to as the HDDR [1]) 311, a second information recording apparatus (HDD-equipped DVD recorder [2], hereinafter referred to as the HDDR [2]) 321, a third information recording apparatus (HDD-equipped DVD recorder [3], hereinafter referred to as the HDDR [3]) 331, a first personal computer (hereinafter referred to as the PC [1]) 341 and a second personal computer (hereinafter referred to as the PC [2]) 351.

The router 301 may be either wired to or wirelessly connected to recording/reproducing apparatuses (including an external HDD and a USB memory) and personal computers, as far as it serves as a router (hub) in a LAN widely available as a public network. In the example shown in FIG. 3, it is assumed that the HDDR [3] (the third information recording apparatus) and the PC [2] (the second personal computer) are able to wirelessly transmit or receive image data or control signals to or from the router 301.

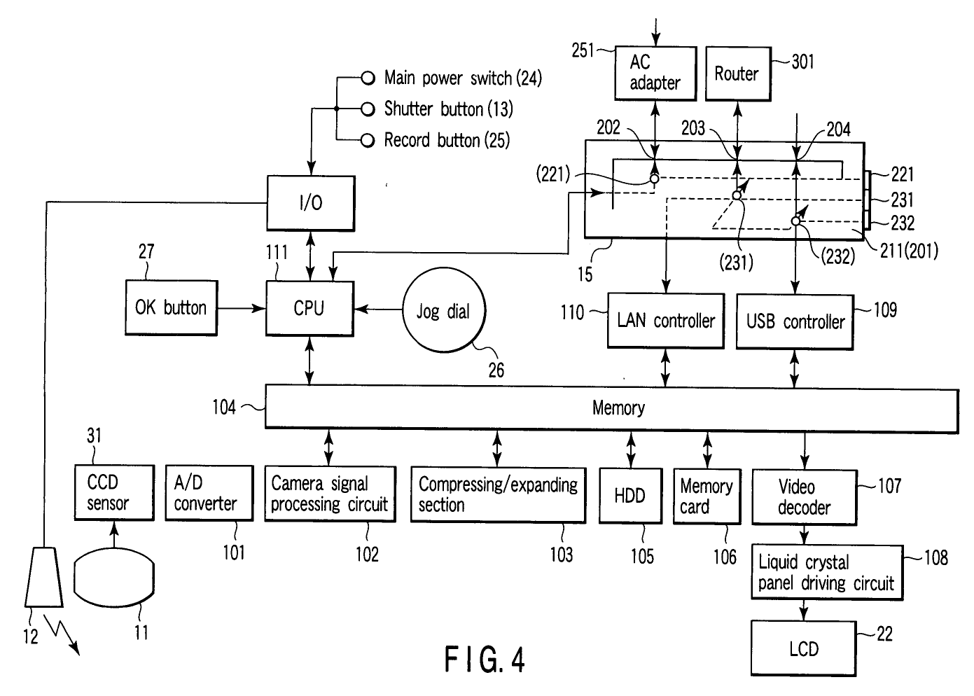

FIG. 4 is a schematic diagram showing an example of the control block of the camera apparatus 1 shown in FIGS. 1A and 1B.

An object image captured through the image pickup lens 11 is imaged on an imaging surface of an image pickup element 31, which is, for example, a CCD sensor. The image formed on the imaging surface is converted to an analog signal (picked-up image data).

The analog signal (picked-up image data) is supplied from the CCD sensor 31 to an analog-digital (A/D) converter 101, which is controlled by a CPU (main control circuit) 111. The A/D converter 101 converts the analog signal to a digital image signal. The digital signal is input to a camera signal processing circuit 102.

In the camera signal processing circuit 102, the digital data of the picked-up image, which has been converted by the A/D converter 101, is subjected to processes, for example, gamma correction, color signal separation and white balance adjustment.

The data of the picked-up image output from the camera signal processing circuit 102, i.e., the image to be recorded, which has been captured through the image pickup lens 11, is input to a liquid crystal panel driving circuit (LCD driver) 108 via a video decoder 107. The liquid crystal panel driving circuit 108 causes the image to be displayed in an LCD panel (hereinafter referred to simply as the LCD) 22 (see FIG. 1B) mounted on the frame 21.

In a recording time, the data of the picked-up image output from the camera signal processing circuit 102 is compressed by a compressing/expanding section 103, and thereafter recorded via a memory circuit 104 into a main recording medium, such as a hard disk drive (hereinafter referred to as the HDD) 105 or a removable recording medium, such as a memory card (nonvolatile memory) 106.

In the compressing/expanding section 103, pictures are compressed by known compression systems: for example, a still picture is compressed by the JPEG format and a moving (non-still) picture is compressed by the MPEG format. A semiconductor memory, such as an SD card (a registered trademark) or a mini-SD (a registered trademark), may be used as the memory card 106.

When an image recorded in the HDD 105 or the memory card 106 is reproduced, the image is read from the HDD 105 or the memory card 106, expanded by the compressing/expanding section 103, and supplied to the video decoder 107 via the memory circuit 104. Then, the image data supplied to the video decoder 107 is displayed in the LCD 22 via the liquid crystal panel driving circuit 108.

The HDD 105 may be replaced by, for example, an optical disk. Further, a large-capacity memory card may be used as a main recording medium.

The image data of the still or moving picture stored in the HDD 105 or the memory card 106 can be selectively transferred to any of the HDDR [1] 311, the HDDR [2] 321, the HDDR [3] 331, the PC [1] 341 and the PC [2] 351 by means of the router 301 (see FIG. 3) via the cradle 201 (see FIG. 2) connected to the adapter connecting section 15. In the case of one-to-one connection between the camera apparatus 1 and the external equipment, for example, the PC [1] 341, the PC [2] 351 or a USB memory (not shown), the USB may be used to transfer data between the HDD 105 or the memory card 106 and the external equipment. Further, known various standards such as the IEEE 139.4, and a parallel bus may be used as the interface.

An interface controller 109 is interposed between an arbitrary interface and the memory circuit 104. A LAN controller 110 is used for data transfer via the router 301.

Image data transfer by means of the camera apparatus shown in FIGS. 1A to 4 will now be described. The transfer method described below is a mere representative example. As far as the image data recorded in the recording device (the HDD 105 or the memory card 106) of the camera apparatus 1 can be transferred to (stored in) the recording medium selected by the method described below, the transfer method of the present invention is not confined by the description herein or the drawings attached hereto.

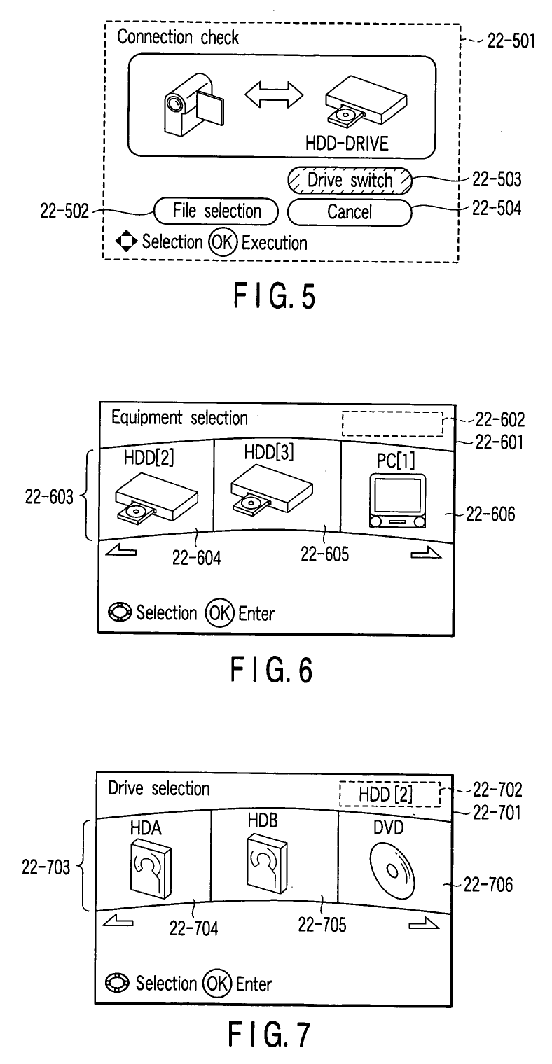

As described above with reference to FIG. 3, in the state where the electronic camera 1 and the router 301 are connected via the cradle 201, if the LAN button 231 of the cradle 201 is turned on, the liquid crystal panel (LCD) 22 displays a connection check screen, which will be described below with reference to FIG. 5.

A “connection check screen” 22-501 shown in FIG. 5 displays the camera apparatus 1 and a recording apparatus currently connected thereto (that had been set as an object to be connected) of all apparatuses, such as the recording/reproducing apparatuses (HDDRs) and PCs connected to the router 301 shown in FIG. 3. The LCD 22 also displays predetermined indications, for example, a “file selection” icon 22-502, a “drive switch” icon 22-503, a “cancel” icon 22-504, etc. FIG. 5 shows a mere example, and the displayed icons, the display pattern (layout) or the characters displayed integrally with the icons may be changed arbitrarily.

The “file selection” icon 22-502 is an indication mark. (GUI=Graphical User Interface), which prompts the user to input a file to select. When the user designates the file selection by pushing the OK button 27, a control signal, which is to execute the displayed mode or corresponds to a specific input instruction, is input to the CPU 111. The “drive switch” icon 22-503 is an indication mark (GUI), which prompts the user to input a drive (equipment) to select. When the user designates the drive selection by pushing the OK button 27, a control signal to display the drive (equipment) selection screen is input to the CPU. The “cancel” icon 22-504 is an indication mark (GUI), which prompts the user to input a control instruction to cancel the present selection state and return to the previous screen or the standby screen.

In this state shown in FIG. 5, when the “drive selection” icon 22-503 is selected by means of the OK button 27 and the OK button 27 is turned on, an execution signal is input to the CPU 111 and the “equipment selection screen” 22-601, for example, as shown in FIG. 6, is displayed (the display is switched from the “connection check screen” 22-501 shown in FIG. 5 is switched to the “equipment selection screen” 22-601).

The “equipment selection screen” 22-601 shown in FIG. 6 includes a “selected equipment name display section” 22-602, which displays the name of a recording/reproducing apparatus connected to the router 301 (or the identification name set by the user) such that current image data (including an “image file (folder)” or an “album (management unit of the folder)”) can be transferred (as viewed from the camera apparatus 1). The “equipment selection screen” 22-601 also includes a scroll line 22-603, which continuously changes the indications by rotating the jog dial 26 clockwise or counterclockwise (in accordance with the direction of rotation).

The scroll line 22-603 displays first to third display regions 22-604 to 22-606, which indicate identification marks (indications) indicative of the types of the recording/reproducing apparatuses connected to the router 301 shown in FIG. 3. Thus, the scroll line 22-603 displays up to three (three types of) recording/reproducing apparatuses at a time. The “selected equipment name display section” 22-602 displays the name of the recording/reproducing apparatus displayed in the central display region of the scroll line 22-603, that is, the second display region 22-605, in association with the operation of the jog dial 26.

In the example shown in FIG. 6, the first to third display regions 22-604 to 22-606 display the indications (identification marks) corresponding to the HDDR [2] 321, the HDDR [3] 331 and the PC [1] 341 of all apparatuses connected to the router 301, i.e., the HDDR [1] 311, the HDDR [2] 321, the HDDR [3] 331, the PC [1] 341 and the PC [2] 351. [0055] In this state, if the jog dial 26 is rotated, for example, clockwise, the identification mark (indication) of the HDDR [3] displayed in the second display region 22-602 is shifted to the third display region 22-606. That is, the second display region 22-605 displays the identification mark (indication) HDDR [2]. Accordingly, the first display region 22-604 displays the identification mark HDDR [1].

To the contrary, if the jog dial 26 is rotated counterclockwise in the state where the first to third display regions 22-604 to 22-606 of the scroll line 22-603 display the HDDR [2] 321, the HDDR [3] 331 and the PC [1] 341, the identification mark (indication) of the HDDR [3] displayed in the second display region 22-605 is shifted to the first display region 22-604. The second display region 22-605 displays the identification mark (indication) PC [1]. Accordingly, the third display region 22-606 displays the identification mark PC [1].

In the state where the scroll line 22-603 displays the identification marks representing the three (three types of) recording/reproducing apparatuses, when the OK button 27 is turned on, the recording/reproducing apparatus corresponding to the display mark displayed in the central portion, that is the second display region 22-605, is selected. At this time, the second display region of the scroll line 22-603 is changed to, for example, an inverse display, so that the user can be notified of the selection. Simultaneously, the “selected equipment name display section” 22-602 displays the name of the selected recording/reproducing apparatus or the identification name set by the user.

When the equipment (drive) is selected by the sequence shown in FIG. 6, a “drive selection screen” 22-701, for example, as shown in FIG. 7, is displayed (the display is switched from the “equipment selection screen” shown in FIG. 6 to the “drive selection screen”).

The “drive selection screen” 22-701 shown in FIG. 7 includes a “selected drive (medium) name display section” 22-702, which displays the name of a recording medium provided in the recording/reproducing apparatus selected by the equipment selection shown in FIG. 6 (or the identification name set by the user) (as viewed from the camera apparatus 1). The “drive selection screen” 22-701 also includes a scroll line 22-703, which continuously changes the indications by rotating the jog dial 26 clockwise or counterclockwise (in accordance with the direction of rotation). In many video recording apparatuses of a large recording capacity, such as a hard disk (HDD)-equipped DVD recorder which is widely available at present, two or more HDDs are provided as recording media. Further, image data can be recorded in an optical disk or a semiconductor memory (memory card) of the DVD specification. Therefore, the user need to specify (designate) a recording medium in advance (as clear from the block diagram shown in FIG. 4, either the HDD 105 or the memory card 106 can be selected as a recording medium in the main body of the camera apparatus 1).

In the example shown in FIG. 7, the scroll line 22-703 displays first to third display regions 22-704 to 22-706, which indicate identification marks (indications) indicative of up to three types of the recording media loaded in the currently selected recording/reproducing apparatus. Thus, the scroll line 22-703 displays three types of the recording media at a time, as well as in the above-described example of display shown in FIG. 6. The “selected drive (medium) name display section” 22-702 displays the name of the recording/reproducing apparatus displayed in the central display region of the scroll line 22-703, that is, the second display region 22-705, in association with the operation of the jog dial 26.

Assume that the HDD-equipped DVD recorder selected in the selection screen shown in FIG. 6 (the HDDR [3] 331 connected to the router 301 in FIG. 3) is selected, and the HDDR [3] contains first and second hard disk drives (HDA and HDB) and an optical disk drive (DVD), which can record information (image data) on an optical disk of the DVD specification (not shown). A method for selecting one of the drives will be described below.

The first to third display regions 22-704 to 22-706 of the scroll line 22-703 respectively display identification marks corresponding to the HAD, the HDB and the DVD.

In this state, if the jog dial 26 is rotated clockwise, the identification marks (indications) displayed in the respective display regions of the scroll line 22-703 do not change, because there are three selectable drives (recording media) in this example. The inverse display of the identification mark (indication) HDB in the second display region 22-705 is canceled, and the identification mark (indication) DVD in the third display region 22-706 is turned to the inverse display. Apparently, the inverse display is shifted from the identification mark HDB in the second display region 22-705 to the identification mark DVD in the third display region 22-706.

To the contrary, if the jog dial 26 is rotated counterclockwise, the inverse display is shifted from the identification mark HDB in the second display region 22-705 to the identification mark HDA in the first display region 22-704.

In the state where the identification mark of the desired recording medium in the scroll line 22-703 is inversed by operating the jog dial 26 and the OK button 27 is turned on, the inverse-displayed drive (recording medium) is specified (selected) as the recording medium to which image data is transferred (recorded) from the camera apparatus 1. In this state, when the “connection check screen” 22-501 shown in FIG. 5 is displayed again, the “file selection” icon 22-502 is selected and inverse-displayed by the OK button 27 and the OK button is turned on, the desired image data (including an “image file (folder)” or an “album (management unit of the folder)”) can be transferred (recorded) from the camera apparatus 1 to the recording medium which has been selected in accordance with the sequences shown in FIGS. 5 to 7.

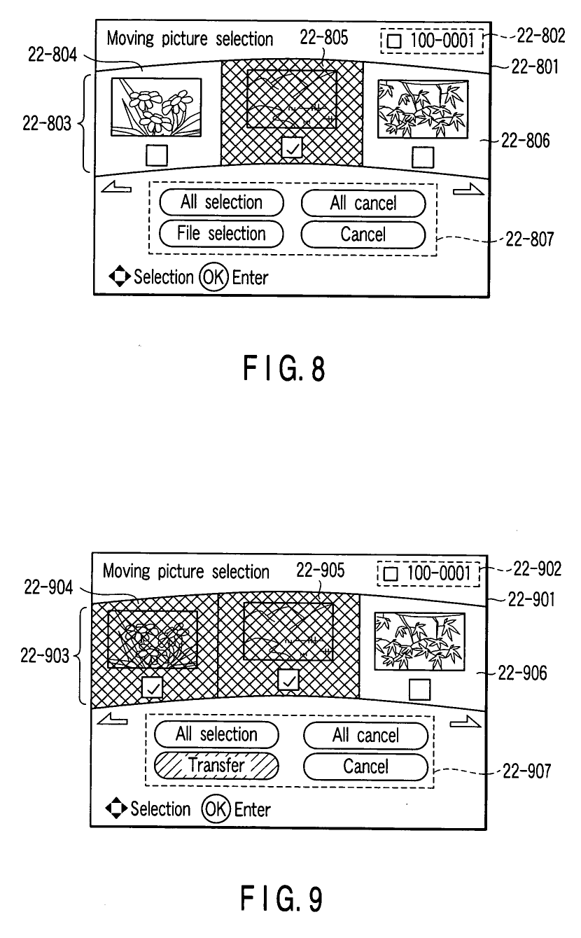

An example of the sequence for transferring image data (moving picture) from the camera apparatus 1 to the recording medium selected by the sequences shown in FIGS. 5 to 7 will now be described with reference to FIGS. 8 and 9. The transfer method described below is a mere example. As far as the moving picture recorded in the recording device (the HDD 105 or the memory card 106) of the camera apparatus 1 can be transferred to (stored in) the recording medium selected by the method described above with reference to FIGS. 5 to 7, the transfer method of the present invention is not confined by the description herein or the drawings attached hereto.

When the “file selection” icon 22-502 shown in FIG. 5 is selected by the OK button 27 and the OK button 27 is turned on, a “moving picture selection screen” 22-801 as shown in FIG. 8 is displayed.

The “moving picture selection screen” 22-801 shown in FIG. 8 includes a scroll line 22-803 similar to the above-described display example shown in FIG. 6 or 7. The scroll line 22-803 includes first to third display regions 22-804 to 22-806. The “moving picture selection screen” 22-801 also displays an “image data title display section” 22-802, which displays the title assigned to the image data displayed in the second display region 22-805 of the first to third display regions 22-804 to 22-806 (or the identification name set by the user). If the title (identification name) to be displayed in the “image data title display section” 22-802 is not set, for example, “the date”, “the serial number” or “the image pickup time” of the same date is assigned to the image data by the OS (operating system) of the camera apparatus 1 as a predetermined management number.

Further, check boxes are indicated together with the image data (quasi-playback images or thumbnail images) displayed in the first to third display regions 22-804 to 22-806.

In this state, the image data corresponding to the check box in which the check mark is written, i.e., the image that the user wishes to transfer, can be transferred to the recording medium selected in the previous step (the OK button 27 is turned on).

If an ON signal is input with respect to the image data corresponding to the check box which has already been checked by pushing the OK button 27, the check mark in the check box is canceled.

The “moving picture selection screen” 22-801 shown in FIG. 8 also includes a file selection and transfer instruction icon (GUI) group 22-807 to specify a file to be transferred, in addition to the scroll line 22-803 (the first to third display regions 22-804 to 22-806). The file selection and transfer instruction icon (GUI) group 22-807 includes, for example, the icons “all selection”, “all cancel”, “cancel” and “transfer”. Thus, if all data in a desired “image file (folder)” or “album (management unit of the folder)” is to be transferred, the process of specifying the image data to be transferred (including the “image file (folder)” or “album (management unit of the folder)”) (the process of inputting the check mark in the check box) is simplified by using the file selection and transfer instruction icon group 22-807.

Then, when all image data to be transferred (by the user) (including the “image file (folder)” or “album (management unit of the folder)”) has been specified, if the OK button 27 is pushed, the “transfer” icon of the file selection and transfer instruction icon group 22-807 is inverse-displayed as indicated as a screen 22-901 in FIG. 9.

In this state, when the OK button 27 is turned on, the image data to be transferred, specified by the sequence shown in FIG. 8, is recorded in the recording medium, which has been selected in advance by the sequences shown in FIGS. 5 to 7.

As described above, according to the camera apparatus 1 of the present invention, the recording medium of a desired recording/reproducing apparatus connected to the LAN is specified by the camera apparatus 1 via the cradle 201, and the image data (including the “image file (folder)” or “album (management unit of the folder)”) stored in the camera apparatus 1 can be transferred only by operating the camera apparatus. If the selected recording/reproducing apparatus contains a plurality of recording media, any of the recording media in the recording/reproducing apparatus can be designated.

Therefore, the convenience in the data transfer or reproduction is improved. For example, a picked-up image, in particular a moving picture, can be transferred to a hard disk-equipped recording/reproducing apparatus connected to a TV receiver, which is located apart from the camera apparatus. Then, the picked-up image can be reproduced by the TV receiver. Further, if the camera apparatus does not have enough recording capacity, data can easily be transferred (saved) temporarily by means of only the camera apparatus to an image data storing apparatus that the user wishes to use.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A camera apparatus comprising:
an optical/electrical converting element, which converts a moving picture fetched through a lens to an image signal;
a recording medium which is allowed to store the image signal output from the optical/electrical converting element;
an image signal processing section, which converts the image signal output from the optical/electrical converting element to a signal of a format which the recording medium is allowed to store, and causes the recording medium to store the image signal;
a monitor section, which is allowed to display the image output from the image signal processing section; and
an expansion connecting section, which is allowed to supply the image signal stored in the recording medium to an arbitrary number of external recording apparatuses provided independently of the recording medium,
wherein when an expansion connecting apparatus, which is configured to be detachably connected to the expansion connecting section of the camera apparatus and is allowed to output the image signal stored in the image signal processing section to the arbitrary number of external recording apparatuses through a LAN, is connected to the expansion connecting section, the monitor section is allowed to display the arbitrary number of external recording apparatuses, which are connected to the camera apparatus via the expansion connecting apparatus and to which the image signal stored in the recording medium of the camera apparatus is allowed to be transferred.

2. The camera apparatus according to claim 1, wherein the monitor section is allowed to display at least either of identification marks and names representing types of the arbitrary number of external recording apparatuses, which are connected to the expansion connecting apparatus and detected to be connected via the expansion connecting section.

3. The camera apparatus according to claim 2, wherein when a selected one of the external recording apparatuses, which is detected to be connected via the expansion connecting section, includes a plurality of recording media, the monitor section is allowed to display at least either of identification marks and names representing types of the recording media.

4. A camera apparatus comprising:
an optical/electrical converting element, which converts a moving picture fetched through a lens to an image signal;
a recording medium which is allowed to store the image signal output from the optical/electrical converting element;
an image signal processing section, which converts the image signal output from the optical/electrical converting element to a signal of a format which the recording medium is allowed to store, and causes the recording medium to store the image signal;
a monitor section, which is allowed to display the image output from the image signal processing section;
an expansion connecting section, which is allowed to supply the image signal stored in the recording medium to an arbitrary number of external recording apparatuses provided independently of the recording medium;
a network controller, which is allowed to transfer the image signal through a network to the arbitrary number of external recording apparatuses, when an expansion connecting apparatus, which is configured to be detachably connected to the expansion connecting section and is allowed to output the image signal stored in the image signal processing section to the arbitrary number of external recording apparatuses, is connected to the expansion connecting section; and
a display control section that causes the monitor section to display the arbitrary number of external recording apparatuses, which are connected to the expansion connecting section via the expansion connecting apparatus and to which the image signal stored in the recording medium of the camera apparatus is allowed to be transferred through the network.

5. The camera apparatus according to claim 4, wherein the display control section causes the monitor section to display at least either of identification marks and names representing types of the arbitrary number of external recording apparatuses, which are connected to the expansion connecting apparatus and detected to be connected via the expansion connecting section.

6. The camera apparatus according to claim 5, wherein when a selected one of the external recording apparatuses, which is connected to the expansion connecting apparatus and detected to be connected via the expansion connecting section, includes a plurality of recording media, the display control section causes the monitor section to display at least either of identification marks and names representing types of the recording media.

7. The camera apparatus according to any one of claim 1, further comprising a jog dial, which is allowed to output a control signal to select one of the arbitrary number of external recording apparatuses connected to the expansion connecting section that are displayed on the monitor section so as to transfer the image signal stored in the recording medium through the expansion connecting apparatus to the expansion connecting section by scrolling the identification marks representing the types of the arbitrary number of recording apparatuses displayed on the monitor section.

8. The camera apparatus according to any one of claim 4, further comprising a jog dial, which is allowed to output a control signal to select one of the arbitrary number of external recording apparatuses connected to the expansion connecting section that are displayed on the monitor section so as to transfer the image signal stored in the recording medium through the expansion connecting apparatus to the expansion connecting section by scrolling the identification marks representing the types of the arbitrary number of recording apparatuses displayed on the monitor section.

9. A cradle for a camera apparatus comprising: an optical/electrical converting element, which converts a moving picture fetched through a lens to an image signal; a recording medium which is allowed to store the image signal output from the optical/electrical converting element; an image signal processing section, which converts the image signal output from the optical/electrical converting element to a signal of a format which the recording medium is allowed to store, and causes the recording medium to store the image signal; a monitor section, which is allowed to display the image output from the image signal processing section; and an expansion connecting section, which is allowed to supply the image signal stored in the recording medium to an arbitrary number of external recording apparatuses provided independently of the recording medium, the cradle comprising:
a first connection end connected to an external connecting apparatus which is allowed to be connected to the camera apparatus via a USB interface of all the arbitrary number of external recording apparatuses provided independently of the recording medium;
a second connection end connected to an external connecting apparatus which is allowed to be connected to the camera apparatus via a network of all the arbitrary number of external recording apparatuses provided independently of the recording medium; and
a switching device which switches between the first connection end and the second connection end to be connected to the camera apparatus.

10. The cradle according to claim 9, wherein the arbitrary number of external recording apparatuses are allowed to be connected to the second connection end via a router.
